(19) United States
(12) Patent Application Publication
(10) Pub. No.: US 2007/0083373 A1
(43) Pub. Date: Apr. 12, 2007

(54) Discriminative training of HMM models using maximum margin estimation for speech recognition

(75) Inventors: Chaojun Liu, San Jose, CA (US); David Kryze, Santa Barbara, CA (US); Luca Rigazio, Santa Barbara, CA (US)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/247,854

(22) Filed: Oct. 11, 2005

(51) Int. Cl. G10L 15/14

(52) U.S. Cl. 704/256.2

(57) ABSTRACT

An improved discriminative training method is provided for hidden Markov models. The method includes: defining a measure of separation margin for the data; identifying a subset of training utterances having utterances misrecognized by the models; defining a training criterion for the models based on maximizing the separation margin; formulating the training criterion as a constrained minimax optimization problem; and solving the constrained minimax optimization problem over the subset of training utterances, thereby discriminatively training the models.

### FIELD OF THE INVENTION

The present invention relates generally to discriminative model training and, more particularly, to an improved method for discriminative training of hidden Markov models (HMMs) based on maximum margin estimation.

### BACKGROUND OF THE INVENTION

Discriminative training has been extensively studied over the past decade and has proved to be quite effective for improving automatic speech recognition performance. Minimum classification error (MCE) and maximum mutual information (MMI) are two of the more popular discriminative training methods. Despite their significant progress in this area, many issues related to discriminative training remain unsolved. One issue reported by many researches is that discriminative training methods for speech recognition suffer from the problem of poor generalization capability. In other words, discriminative training can dramatically reduce the error rate for the training data but such significant performance gains cannot be maintained for unseen test data.

Therefore, it is desirable to provide a discriminative training method for hidden Markov models which improves the generalization capability of the models.

### SUMMARY OF THE INVENTION

An improved discriminative training method is provided for hidden Markov models. The method includes: defining a measure of separation margin for the data; identifying a subset of training utterances having utterances misrecognized by the models; defining a training criterion for the models based on the principle of maximizing the separation margin; formulating the training criterion as a constrained minimax optimization problem; and solving the constrained minimax optimization problem over the subset of training utterances, thereby discriminatively training the models.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

In automatic speech recognition, given any speech utterance X, a speech recognizer will choose the word Ŵ as output based on the MAP decision rule as follows:

$$\begin{matrix}\hat{W} = {arg max}_{w} P ( W \text{\textbar} X ) \\ = {arg max}_{w} P ( W ) \cdot P ( X \text{\textbar} W ) \\ = {arg max}_{w} P ( W ) \cdot P ( X \text{\textbar} {λ}_{W} ) \\ = {arg max}_{w} F ( X \text{\textbar} {λ}_{W} )\end{matrix} \qquad ( 1 )$$

where λ_{w} denotes the HMM representing the word W and F(X|λ_{w})=P(W)·P(X|λ_{w}) is called discriminant function. Depending on the problem of interest, a word W is used herein to mean any linguistic unit, such as a phoneme, a syllable, a word, a phrase or a sentence. For discussions purposes, this work is focused on hidden Markov models λ_{w} and assume P(W) is fixed. While the following description is provided with reference to hidden Markov models, it is readily understood that the broader aspects of the present invention are also applicable to other types of acoustic models.

For a speech utterance, Xᵢ assuming its true word identity as Wᵢ^{T}, the multi-class separation margin for Xᵢ is defined as:

$$\begin{matrix}d ( {X}_{i} ) = F ( {X}_{i} \text{\textbar} λ {w}_{i}^{T} ) - {max}_{{w}_{j} ∈ Ω {w}_{j} \neq {w}_{i}^{T}} F ( {X}_{i} \text{\textbar} λ {w}_{j} ) \\ = {min}_{{w}_{j} ∈ Ω {w}_{j} \neq {w}_{i}^{T}} [ F ( {X}_{i} \text{\textbar} λ {w}_{i}^{T} ) - F ( {X}_{i} \text{\textbar} λ {w}_{j} ) ]\end{matrix} \qquad \begin{matrix}( 2 ) \\ \\ ( 3 )\end{matrix}$$

where Ω denotes the set of all possible words.

Obviously, if d(Xᵢ)<0, Xᵢ will be incorrectly recognized by the current HMM set, denoted as Λ; if d(Xᵢ)>0, Xᵢ will be correctly recognized by the models Λ.

Given a set of training data D={X₁, X₂ . . . , X_{N}}, we usually know the true word identities for all utterances in D, denoted as L={W₁^{T}, W₂^{T}, . . . W_{N}^{T}}. Thus, we can calculate the separation margin (also referred to hereafter as margin) for every utterance in D based on the definition in equation (2) or (3). If we want to estimate the HMM parameters Λ, one desirable estimation criterion is to minimize the total number of utterances in the whole training set which have negative margins as in the standard MCE estimation. Furthermore, motivated by the large margin principle in machine learning, even for those utterances which all have positive margins, we may still want to maximize the minimum margin among them towards an HMM-based large margin classifier. Based on the machine learning theory, a large margin classifier usually leads to a much lower generalization error rate in a new testing set and shows a more robust and better generalization capability. In this report, we will show how to estimate HMMs for speech recognition based on the above-mentioned principle of maximizing minimum multi-class separation margin.

First of all, from all utterances in D, we need to identify a subset of utterances,
S={Xᵢ|XᵢεD and 0≦d(Xᵢ)≦γ} (4)
where γ>0 is a pre-set positive number. Analogically, we call S as support vector set and each utterance in S is called a support token, which has relatively small positive margin among all utterances in training set D. In other words, all utterances in S are relatively close to the classification boundary even though all of them locate in the right decision regions. To achieve a better generalization power, it is desirable to adjust decision boundaries, which are implicitly determined by all models, through optimizing HMM parameters Λ to make all support tokens as far from the decision boundaries as possible, which will result in a robust classifier with better generalization capability. This idea leads to estimating the HMM models Λ based on the criterion of maximizing the minimum margin of all support tokens, which is named as large margin estimation (LME) or maximum margin estimation (MME) of HMM:

$$\tilde{Λ} = {arg max}_{Λ} {min}_{{X}_{i} ∈ S} d ( {X}_{i} ) \qquad ( 5 )$$

where the above maximization and minimization are performed subject to the constraints that d(Xᵢ)>0 for all XᵢεS. The HMM models, \tilde{Λ}, estimated in this way, are called large margin or maximum margin HMMs. For simplicity of explanation, we will only use the term large margin estimation hereafter.

Considering equation (3), large margin HMMs can be equivalently estimated as follows:

$$\tilde{Λ} = {arg max}_{Λ} {min}_{{X}_{i} ∈ S , {w}_{j} ∈ Ω , {w}_{j} \neq {w}_{i}^{T}} [ F ( {X}_{i} \text{\textbar} λ {w}_{i}^{T} ) - F ( {X}_{i} \text{\textbar} λ {w}_{j} ) ] \qquad ( 6 )$$

subject to
F(Xᵢ|λWᵢ^{T})−F(Xᵢ|λwⱼ)>0 (7)
for all XᵢεS and wⱼεΩwⱼ≠Wᵢ^{T}.

Finally, the above optimization can be converted into a standard minimax optimization problem as:

$$\tilde{Λ} = {arg max}_{Λ} {max}_{{X}_{i} ∈ S , {w}_{j} ∈ Ω , {w}_{j} \neq {w}_{i}^{T}} [ F ( {X}_{i} \text{\textbar} λ {w}_{j} ) - F ( {X}_{i} \text{\textbar} λ {w}_{i}^{T} ) ] \qquad ( 8 )$$

where the minimax optimization is subject to the following constraint:
F(Xᵢ|λwⱼ)−F(Xᵢ|λWᵢ^{T})<0 (9)
for all XᵢεS and wⱼεΩwⱼ≠wᵢ^{T}.

Since large margin estimation is derived from support vector machines in machine learning, the definition of the training set is analogous to that of the support vector set for support vector machines as seen in equation (4) above. In other words, the support vector set only consists of positive tokens (i.e., training data correctly recognized by the baseline model). Negative or misrecognized tokens are discarded in the large margin estimation approach. As a result, large margin estimation typically uses minimum classification error training to bootstrap the training (i.e., uses the MCE model as a seed model to start the training).

The present invention proposes to further include the negative tokens in the support vector set. A new definition of the support vector set is defined as follows:
S={Xᵢ|XᵢεD and d(Xᵢ)≦γ} (10)
where γ is a positive constant. In other words, a subset of training data is identified which includes data misrecognized by the models. However, the subset of training data may also include data correctly recognized by the models. Accordingly, the minimax optimization problem may be solved using this new support vector set. It is readily understood that different optimization approaches for solving this problem are within the scope of the present invention.

Assuming there are misrecognized tokens, the minimization in the criterion of equation (5) will chose the most negative token which is farthest from the decision boundary and locates in the wrong decision region. This is very different from the original large margin estimation training where the minimization will always choose the token that is nearest to the decision boundary but locates in the correct decision region. According to the criterion, the maximization will push the negative tokens to cross the decision boundaries so they will have positive margins. This is similar to the minimum classification error training but in a more direct and effective fashion. In this way, large margin estimation no longer needs to use MCE to bootstrap, thereby completely removing any need for MCE in the training process.

The present invention directly applies the large margin estimation (LME) to both misrecognized data and correctly recognized data, as opposed to previous method in which only correctly recognized training data can be used in the training. It takes full benefit of LME because more training data participate in the training, and therefore can achieve higher accuracy than the existing LME method. Furthermore, in large vocabulary continuous speech recognition (LVCSR) tasks, only a very small percentage of training data will be correctly recognized by the baseline models. In the previous LME method, the benefit of large margin estimation will be greatly limited due to lack of applicable training data, or it may not be able to apply at all when none of the training data is correctly recognized, which is common for LVCSR tasks. But this invention has no such problem and can be directly applied to LVCSR tasks. Another advantage of this invention is that it does not need to use MCE to bootstrap the training as opposed to the existing LME method, so the overall training time is shorter.

Constraints for the large margin estimation do not guarantee the existence of a minimax point. As an illustration of this, let's assume a simple case with only two classes m1 and m2 and there is a support token X close to the decision boundary. If we pull m1 and m2 together at the same time, we can keep the boundary unchanged but increase the margin defined in equation (3) as much as we want. As models move toward X, the absolute values of both F(X|m1) and F(X|m2) increase, so does the margin as well, although the relative position of X related to the boundary actually does not change at all.

More constraints must be introduced in the minimax optimization procedure to make sure that the optimal point does exist. In one exemplary approach, a localized optimized strategy is adopted. Rather than optimizing parameters of all models at the same time, only one selected model is adjusted in each step and then the process iterates to update another model until the minimum margin is maximized.

The iterative localized optimization may be summarized as follows:
Repeat
   1. Identify the support set S based on the current model set Λ⁽ⁿ⁾.
   2. Choose the support token, to say Xₖ, from S which currently gives the minimum margin; Choose the true model of Xₖ, to say λₖ⁽ⁿ⁾ for optimization in this iteration.
   3. Minimizing the margin by ONLY updating the model λₖ:
      λₖ⁽ⁿ⁾ [symbol] λₖ⁽ⁿ⁺¹⁾.
   4. n=n+1.
until some convergence conditions are met.

In the above iterative localized optimization method, in each iteration, only one model, to say λₖ, is updated based on the minimax optimization given in equation (8) so that we only need to consider those functions which are relevant to the currently selected model. The minimax optimization can be re-formulated as:

$${λ}_{k}^{( n + 1 )} = arg min {max}_{{X}_{i} ∈ S , i {\neq }_{j j = k or i = k}} [ F ( {X}_{i} \text{\textbar} λ {w}_{j} ) - F ( {X}_{i} \text{\textbar} λ {w}_{i}^{T} ) ] \qquad ( 11 )$$

subject to the constraints in equation (10). This localized minimax optimization can be numerically solved by using some optimization software tools. Given a large number of parameters in HMMs, it is usually too slow to use a general purpose minimax tool to solve this optimization problem.

One alternative is to use a GPD-based algorithm to solve the minimax problem in equation (11) in an approximate way. First of all, based on equation (11), we construct a differentiable objective function as follows:

$$Q ( {λ}_{k} ) = \frac{1}{η} log \{ {\sum }_{{X}_{i} ∈ S j \neq i i = k or j = k}^{} exp [ η F ( {X}_{i} \text{\textbar} {λ}_{{W}_{j}} - η F ( {X}_{i} \text{\textbar} {λ}_{{W}_{i}} ) ] \} \qquad ( 12 )$$

where η>1 is a constant. As η→∞, Q(λₖ) will approach the maximization in equation (11). Then, the GPD algorithm can be used to update the model parameters, λₖ, in order to minimize the above approximate objective function, Q(λₖ).

Assume each speech unit, e.g., a word W, is modeled by an N-state CDHMM with parameter vector λ=(π, A, θ), where π is the initial state distribution, A={aᵢⱼ|1≦i, j≦N} is transition matrix, and θ is parameter vector composed of mixture parameters θᵢ={wᵢₖ, mᵢₖ, rᵢₖ}ₖ=1, 2, . . . , ₖ for each state i, where K denotes number of Gaussian mixtures in each state. The state observation p.d.f. is assumed to be a mixture of multivariate Gaussian distribution. In many cases, we prefer to use multivariate Gaussian distribution with diagonal precision matrix. Given any speech utterance Xᵢ={xᵢ₁, xᵢ₂, . . . xi_{R}}, F(Xᵢ|λwⱼ) can be calculated as:

$$F ( {X}_{i} \text{\textbar} λ {w}_{j} ) = log ( P ( Xi \text{\textbar} λ {w}_{j} ) P ( {w}_{j} ) ) log P ( {W}_{j} ) + log {\prod }_{{S}_{1}} + {\sum }_{t = 2}^{T} log {a}_{{S}_{t - 1} {S}_{t}} + \frac{1}{2} {\sum }_{t = 1}^{T} {\sum }_{d = 1}^{D} [ log {r}_{{S}_{t} {l}_{t} d} - {{r}_{{S}_{t} {l}_{t} d} ( {x}_{itd} - {m}_{{S}_{ t} {l}_{t} d} )}^{2} ] \qquad ( 13 )$$

Here we only consider a simple case, where we only re-estimate mean vectors of CDHMMs based on the large margin principle while keeping all other CDHMM parameters constant during the large margin estimation. For any utterance Xᵢ in the support token set S, we can re-write F(Xᵢ|λᵢ) and F(Xᵢ|λⱼ) according to equation (13) as follows:

$$\begin{matrix}F ( {X}_{i} \text{\textbar} {λ}_{i} ) \approx {C}^{′} - \frac{1}{2} {\sum }_{t = 1}^{T} {\sum }_{d = 1}^{D} [ log {r}_{{S}_{t}^{′} {l}_{t}^{′} d} - {{r}_{{S}_{t}^{′} {l}_{t}^{′} d} ( {x}_{itd} - {m}_{{S}_{t}^{′} {l}_{t}^{′} d} )}^{2} ] & ( 14 ) \\ F ( {X}_{i} \text{\textbar} {λ}_{j} ) \approx {C}^{″} - \frac{1}{2} {\sum }_{t = 1}^{T} {\sum }_{d = 1}^{D} [ log {r}_{{S}_{t}^{″} {l}_{t}^{″} d} - {{r}_{{S}_{t}^{″} {l}_{t}^{″} d} ( {x}_{itd} - {m}_{{S}_{t}^{″} {l}_{t}^{″} d} )}^{2} ] & ( 15 )\end{matrix}$$

where C′ and C″ are two constants independent from mean vectors. In this case, the discriminant functions F(Xᵢ|λᵢ) and F(Xᵢ|λⱼ) can be represented as a summation of some quadratic functions related to mean values of CDHMMs. Then we can represent the decision margin F(Xᵢ|λᵢ)−F(Xᵢ|λⱼ) as:

From eqs. (12) and (16), it is straightforward to calculate the gradient of the objective function, Q(λₖ), with respect to each mean vector in the model λₖ.

At last, we can use the GPD algorithm to adjust λₖ to minimize the objective function as follows:

$$F ( {X}_{i} \text{\textbar} {λ}_{i} ) - F ( {X}_{i} \text{\textbar} {λ}_{j} ) \approx C - {\sum }_{t = 1}^{T} {\sum }_{d = 1}^{D} [ {{r}_{{S}_{t}^{′} {l}_{t}^{′} d} ( {x}_{itd} - {m}_{{S}_{t}^{′} {l}_{t}^{′} d} )}^{2} - {{r}_{{S}_{t}^{″} {l}_{t}^{″} d} ( {x}_{itd} - {m}_{{S}_{t}^{″} {l}_{t}^{″} d} )}^{2} ] \\ where C = {C}^{′} - {C}^{″} \qquad ( 16 )$$

$${μ}_{sql}^{( n + 1 )} = {μ}_{sql}^{( n )} - ∈ \frac{\partial Q ( {λ}_{k} )}{\partial {μ}_{sql}} {\vert}_{{λ}_{k} = {λ}_{k}^{( n )}} \qquad ( 17 )$$

where μ_{sql}⁽ⁿ⁺¹⁾ denotes the I-th dimension of Gaussian mean vector for the q-th mixture component of state S of HMM model λₖ at (n+1 )-th iteration.

In an alternative approach, the definition of margin may be changed to a relative separation margin as defined below:

$$\tilde{d} ( {X}_{i} ) = {min}_{{w}_{j} ∈ Ω {w}_{j} \neq {w}_{i}^{T}} [ \frac{F ( {X}_{i} \vert {λ}_{{w}_{i}^{T}} ) - F ( {X}_{i} \vert λ {w}_{j} )}{F ( {X}_{i} \vert {λ}_{{w}_{i}^{T}} )} ] \qquad ( 18 )$$

If the discriminant functions F(·) are defined as in equation (1), for all support tokens in the set S defined in equation (10), the relative margin d(Xᵢ) will be less than 1. Since the relative margin has an upperbound by definition, the maximum value of relative margin always exists. However, in many cases, F(Xᵢ|λ) is defined as the log-likelihood of Xᵢ given model set Λ, so F(Xᵢ|λwᵢ^{T})<0. To make the relative margin meaningful (i.e., positive values for correctly recognized data and negative values for misrecognized data), we slightly modify its definition as:

$$\tilde{d} ( {X}_{i} ) = {min}_{{w}_{j} ∈ Ω {w}_{j} \neq {w}_{i}^{T}} [ \frac{F ( {X}_{i} \vert λ {w}_{j} ) - F ( {X}_{i} \vert {λ}_{{w}_{i}^{T}} )}{F ( {X}_{i} \vert λ {w}_{j} )} ] \qquad ( 19 )$$

Thus, for correctly recognized data, F(Xᵢ|λwⱼ)<F(Xᵢ|λWᵢ^{T}), d(Xᵢ)>0. Similarly, we define the support vector set S as equation (10). Therefore, our new training criterion is defined as

$$\tilde{Λ} = {arg min}_{Λ} {max}_{{x}_{i} ∈ S , {w}_{j} ∈ Ω , {w}_{j} \neq {w}_{i}^{T}} [ \frac{F ( {X}_{i} \vert {λ}_{{w}_{i}^{T}} )}{F ( {X}_{i} \vert {λ}_{{w}_{j}} )} - 1 ] \qquad ( 20 )$$

where Ω denotes the set of all possible words. This technique is referred to large relative margin estimation (LRME) or maximum relative margin estimation (MRME) of HMMs. In this case, different optimization approaches can be used for updating all model parameters at the same time.

For example, an iterative approach is proposed based on the generalized probabilistic descent (GPD) algorithm. First, a differentiable objective function is constructed. To do so, a summation of exponential functions to approximate the maximization in equation (20) as follows:

$$\begin{matrix}{max}_{{X}_{i} ∈ S , {w}_{j} ∈ Ω , {w}_{j} \neq {w}_{i}^{T}} [ \frac{F ( {X}_{i} \vert {λ}_{{w}_{i}^{T}} )}{F ( {X}_{i} \vert λ {w}_{j} )} - 1 ] & \\ \begin{matrix}\approx log \{ {\sum }_{{X}_{i} ∈ S , {w}_{j} ∈ Ω , {w}_{j} \neq {w}_{i}^{T}} {exp [ η d ( {X}_{i} , {λ}_{{w}_{j}} , {λ}_{{w}_{i}^{T}} ] \}}^{1 \text{/} η} d ( {X}_{i} , {λ }_{{W}_{j}} , {λ }_{{W}_{i}^{T}} ) \\ = {d}_{ij} \\ = \frac{F ( {X}_{i} \vert {λ}_{{w}_{i}^{T}} )}{F ( {X}_{i} \vert λ {w}_{j} )} - 1\end{matrix} & ( 21 )\end{matrix}$$

where η>1. As η→∞, the continuous function in the right hand side of equation (21) will approach the maximization in the left hand side.

Therefore, we define the objective function as:

$$\begin{matrix}Q ( Λ ) = \frac{1}{η} log \{ {\sum }_{{X}_{i} ∈ S , {w}_{j} ∈ Ω , {w}_{j} \neq {w}_{i}^{T}} exp ( η {d}_{ij} ) \} & ( 22 ) \\ = \frac{1}{η} log \{ {\sum }_{{X}_{i} ∈ S , {w}_{j} ∈ Ω , {w}_{j} \neq {w}_{i}^{T}} \sum exp ( η {d}_{ij} ) \} & ( 23 ) \\ = \frac{1}{η} log {Q}_{1} & ( 24 )\end{matrix}$$

Now, we can use GPD algorithm to adjust Λ to minimize the objective function of Q(Λ). To maintain HMM model constraints during the optimization process, we need to define the same transformations for model parameters as known in minimum classification error training methods. For Gaussian means, the transformation is

$${\tilde{μ}}_{skl}^{m} = \frac{{μ}_{skl}^{m}}{{σ}_{skl}^{m}}$$

where \tilde{μ}ₛₖₗ^{m} is the transformed Gaussian mean, μₛₖₗ^{m} and σₛₖₗ^{m} are the original Gaussian mean and variance, respectively. Then it can be shown that the iterative adjustment of Gaussian means follows

$$\begin{matrix}{\tilde{μ}}_{skl}^{m} ( n + 1 ) = {\tilde{μ}}_{skl}^{m} ( n ) - ∈ \frac{\partial Q ( Λ )}{\partial {\tilde{μ}}_{skl}^{m}} \vert Λ = {Λ}_{n} & ( 25 ) \\ {μ}_{skl}^{m} ( n + 1 ) = {σ}_{skl}^{m} {\tilde{μ}}_{skl}^{m} ( n + 1 ) & ( 26 )\end{matrix}$$

where μₛₖₗ^{m}(n+1) is the I-th dimension of Gaussian mean vector for the k-th mixture component of state s of HMM model m at n+1 iteration.

$$\begin{matrix}\frac{\partial Q ( Λ )}{\partial {Q}_{1}} = \frac{1}{η} \frac{1}{{Q}_{1}} & ( 27 ) \\ \begin{matrix}\frac{\partial {Q}_{1}}{\partial {\tilde{μ}}_{skl}^{m}} = {\sum }_{{X}_{i} ∈ S} \{ {\sum }_{{w}_{j} ∈ Ω , {w}_{j} \neq {w}_{i}^{T}} η exp ( η {d}_{ij} ) \frac{\partial {d}_{ij}}{\partial {\tilde{μ}}_{skl}^{m}} \} \\ = {\sum }_{{X}_{i} ∈ S} \{ δ ( {W}_{i}^{T} - m ) η \frac{\partial F ( {X}_{i} \vert {λ}_{m} )}{\partial {\tilde{μ}}_{skl}^{m}} {\sum }_{{W}_{j} ∈ Ω , {W}_{j} \neq m} \frac{exp ( η {d}_{ij} )}{( {X}_{i} \vert {λ}_{{W}_{j}} )} - \\ ( 1 - δ ( {W}_{i}^{T} - m ) ) \frac{F ( {X}_{i} \vert {λ}_{{W}_{i}^{T}} )}{{F}^{2} ( {X}_{i} \vert {λ}_{m} )} η exp ( η {d}_{ij} ) \frac{\partial F ( {X}_{i} \vert {λ}_{m} )}{\partial {\tilde{μ}}_{skl}^{m}} \}\end{matrix} & ( 28 )\end{matrix}$$

where δ(Wᵢ^{T}−m)=1 when Wᵢ^{T}=m, that is, the true model for utterance Xᵢ is the m-th model in the model set Λ. δ(Wᵢ^{T}−m)=0 when Wᵢ^{T}≠m. As

$$\begin{matrix}\begin{matrix}F ( {X}_{i} \vert {λ}_{m} ) = log L ( {X}_{i} \vert {λ}_{m} ) \\ \approx log L ( {X}_{i} , q ; {λ}_{m} ) \\ = {\sum }_{t = 1}^{T} [ log {a}_{{q}_{t - 1} {q}_{t}}^{m} + {b}_{{q}_{t}}^{m} ( {x}_{t} ) ] + log {π}_{{q}_{0}}^{m}\end{matrix} & ( 29 ) \\ {b}_{j}^{m} ( {x}_{t} ) = {\sum }_{k = 1}^{K} {c}_{jk}^{m} N [ {x}_{t} ; {μ}_{jk}^{m} , {R}_{jk}^{m} ] \\ so & ( 30 ) \\ \frac{\partial F ( {X}_{i} \vert {λ}_{m} )}{\partial {\tilde{μ}}_{skl}^{m}} = {\sum }_{t = 1}^{T} δ ( {q}_{t} - s ) \frac{\partial log {b}_{s}^{m} ( {x}_{t} )}{\partial {\tilde{μ}}_{skl}^{m}} & ( 31 )\end{matrix}$$

where

$$\frac{\partial log {b}_{s}^{m} ( {x}_{i} )}{\partial {\tilde{μ}}_{skl}^{m}} = {{c}_{sk}^{m} ( 2 π )}^{- \frac{D}{2}} {\vert {R}_{sk}^{m} \vert}^{- \frac{1}{2}} {( {b}_{s}^{m} ( {x}_{t} ) )}^{- 1} ( \frac{{x}_{tl} - {μ}_{skl}^{m}}{{σ}_{skl}} ) exp \{ - \frac{1}{2} {\sum }_{l = 1}^{D} {( \frac{{x}_{tl} - {μ}_{skl}^{m}}{{σ}_{skl}} )}^{2} \} \qquad ( 32 )$$

D is the dimension of feature vectors. Rₛₖ^{m} is the covariance matrix for state s and Gaussian mixture component k for HMM model m. Here we assume it is diagonal. q is the best state sequence obtained by aligning Xᵢ using HMM model λₘ.

Combining equations from (27) to (32), we can easily obtain ∂Q(Λ)/∂\tilde{μ}ₛₖₗ^{m} for equation (25). Similar derivations for the variances, mixture weights and transition probabilities can be easily accomplished.

Note that there may be alterative definitions to the one given in equation (19). One alternative definition is

$$\tilde{d} ( {X}_{i} ) = {min}_{{w}_{j} ∈ Ω {w}_{j} \neq {w}_{i}^{T}} [ \frac{exp ( F ( {X}_{i} \vert {λ}_{{w}_{i}^{T}} ) ) - exp ( F ( {X}_{i} \vert {λ}_{{w}_{j}} ) )}{exp ( F ( {X}_{i} \vert {λ}_{{w}_{j}^{T}} ) )} ] \qquad ( 33 )$$

Based on the alternative definition, it is readily understood that the estimation formula for HMM model parameters can be derived.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A discriminative training method for hidden Markov models, comprising:
defining a measure of separation margin for the data;
identifying, based on the definition of the separation margin, a subset of training data having data misrecognized by the models;
defining a training criterion for the models based on maximum margin estimation;
formulating the training criterion as a minimax optimization problem; and
solving the constrained minimax optimization problem over the subset of training data, thereby discriminatively training the models.

2. The discriminative training method of claim 1 wherein each datum of the subset of training data has a separation margin from classification boundaries of the models which is equal to or less than a threshold value.

3. The discriminative training method of claim 1 wherein the subset of training data, S, is
S={Xᵢ|XᵢεD and d(Xᵢ)≦γ}
where Xᵢ is a datum in a set of training data D, d(Xᵢ) is a separation margin for the datum Xᵢ and γ is a constant threshold.

4. The discriminative training method of claim 1 wherein the training criterion is further defined as
$$\tilde{Λ} = {arg max}_{Λ} {min}_{{x}_{i} ∈ S} d ( {X}_{i} )$$
where Λ is an estimated set of models, Xᵢ is a training datum in the subset of training data, S is the subset of training data and d(Xᵢ) is a separation margin for the training datum.

5. The discriminative training method of claim 1 wherein a maximum margin estimation is further defined as a large margin estimation or a large relative margin estimation.

6. The discriminative training method of claim 4 wherein defining the separation margin is as follows
$$d ( {X}_{i} ) = {min}_{{w}_{j} ∈ Ω {w}_{j} \neq {w}_{i}^{T}} [ F ( {X}_{i} \vert {λ}_{{w}_{i}^{T}} ) - F ( {X}_{i} \vert λ {w}_{j} ) ]$$
such that the training criterion is defined as
$$\tilde{Λ} = {arg max}_{Λ} {min}_{{X}_{i} ∈ S {w}_{j} ∈ Ω {w}_{j} \neq {w}_{i}^{T}} [ F ( {X}_{i} \vert {λ}_{{w}_{i}^{T}} ) - F ( {X}_{i} \vert λ {w}_{j} ) ]$$
where λ_{W} denotes a model representing a word W, F(X|λ_{W})=p(W) p(X|λ_{W}) and Ω denotes the set of all possible words.

7. The discriminative training method of claim 6 wherein solving the constrained minimax optimization problem uses an iterative localized optimization algorithm.

8. The discriminative training method of claim 4 wherein defining the separation margin is as follows
$$\tilde{d} ( {X}_{i} ) = {min}_{{w}_{j} ∈ Ω {w}_{j} \neq {w}_{i}^{T}} [ \frac{F ( {X}_{i} \vert {λ}_{{w}_{j}} ) - F ( {X}_{i} \vert {λ}_{{w}_{i}^{T}} )}{F ( {X}_{i} \vert {λ}_{{w}_{j}} )} ]$$
such that the training criterion is defined as
$$\tilde{Λ} = {arg min}_{Λ} {max}_{{X}_{i} ∈ S {w}_{j} ∈ Ω {w}_{j} \neq {w}_{i}^{T}} [ \frac{F ( {X}_{i} \vert {λ}_{{w}_{i}^{T}} )}{F ( {X}_{i} \vert {λ}_{{w}_{j}} )} - 1 ]$$
where λ_{W} denotes a model representing a word W, F(X|λ_{W})=p(W) p(X|λ_{W}) and Ω denotes the set of all possible words.

9. The discriminative training method of claim 4 wherein defining the separation margin is as follows
$$\tilde{d} ( {X}_{i} ) = {min}_{{w}_{j} ∈ Ω {w}_{j} \neq {w}_{i}^{T}} [ \frac{exp ( F ( {X}_{i} \vert {λ}_{{w}_{i}^{T}} ) ) - exp ( F ( {X}_{i} \vert {λ}_{{w}_{j}} ) )}{exp ( F ( {X}_{i} \vert {λ}_{{w}_{i}^{T}} ) )} ]$$
such that the training criterion is defined as
$$\tilde{Λ} = {arg min}_{Λ} [ {max}_{{X}_{i} ∈ S , {w}_{j} ∈ Ω , {w}_{j} \neq {w}_{i}^{T}} exp ( F ( {X}_{i} \vert {λ}_{{w}_{j}} ) - F ( {X}_{i \\} \vert {λ}_{{W}_{i}^{T}} ) ) - 1 ]$$
where λ_{W} denotes a model representing a word W, F(X|λ_{W})=p(W) p(X|λ_{W}) and Ω denotes the set of all possible words.

10. The discriminative training method of claim 8 wherein solving the constrained minimax optimization problem uses a generalized probabilistic descent algorithm.

11. The discriminative training method of claim 9 wherein solving the constrained minimax optimization problem uses a generalized probabilistic descent algorithm.

12. A discriminative training method for hidden Markov models, comprising:
defining a measure of separation margin for the data;
defining a training criterion for the models based on maximum margin estimation;
formulating the training criterion as a constrained minimax optimization problem; and
solving the constrained minimax optimization problem over a subset of training utterances, where the subset of training utterances, S, is
S={Xᵢ|XᵢεD and d(Xᵢ)≦γ}
where Xᵢ is a speech utterance in a set of training data D, d(Xᵢ) is a separation margin for the speech utterance and γ is a predefined positive number.

13. The discriminative training method of claim 12 wherein the training criterion is further defined as
$$\tilde{Λ} = {arg max}_{Λ} { min}_{{X}_{i} ∈ S} d ( {X}_{i} )$$
where Λ is an estimated set of acoustic models.

14. The discriminative training method of claim 12 wherein a maximum margin estimation is further defined as a large margin estimation or a large relative margin estimation.

15. The discriminative training method of claim 13 further comprises defining the separation margin as follows
$$d ( {X}_{i} ) = {min}_{{w}_{j} ∈ Ω {w}_{j} \neq {w}_{i}^{T}} [ F ( {X}_{i} \vert {λ}_{{W}_{i}^{T}} ) - F ( {X}_{i} \vert λ {w}_{j} ) ]$$
such that the training criterion is defined as
$$\tilde{Λ} = {argmax }_{Λ} {min}_{Xi ∈ S {w}_{j} ∈ Ω {w}_{j} \neq {w}_{i}^{T}} [ F ( {X}_{i} \vert {λ}_{{W}_{i}^{T}} ) - F ( {X}_{i} \vert λ {w}_{j} ) ]$$
where λ_{W} denotes a model representing a word W, F(X|λ_{W})=p(W) p(X|λ_{W}) and Ω denotes the set of all possible words.

16. The discriminative training method of claim 15 wherein solving the constrained minimax optimization problem uses an iterative localized optimization algorithm.

17. The discriminative training method of claim 13 further comprises defining the separation margin as follows
$$\tilde{d} ( {X}_{i} ) = {min}_{{w}_{j} ∈ Ω {w}_{j} \neq {w}_{i}^{T}} [ \frac{F ( {X}_{i} \vert {λ}_{{w}_{j}} ) - F ( {X}_{i} \vert {λ}_{{W}_{i}^{T}} )}{F ( {X}_{i} \vert {λ}_{{w}_{j}} )} ]$$
such that the training criterion is defined as
$$\tilde{Λ} = {argmin}_{Λ} {max}_{{X}_{i} ∈ S , {w}_{j} ∈ Ω , {w}_{j} \neq {w}_{i}^{T}} [ \frac{F ( {X}_{i} \vert {λ}_{{W}_{i}^{T}} )}{F ( {X}_{i} \vert {λ}_{{w}_{j}} )} - 1 ]$$
where λ_{W} denotes a model representing a word W, F(X|λ_{W})=p(W) p(X|λ_{W}) and Ω denotes the set of all possible words.

18. The discriminative training method of claim 13 further comprises defining the separation margin as follows
$$\tilde{d} ( {X}_{i} ) = {min}_{{w}_{j} ∈ Ω {w}_{j} \neq {w}_{i}^{T}} [ \frac{exp ( F ( Xi \vert {λ}_{{w}_{i}^{T}} ) ) - exp ( F ( Xi \vert λ {w}_{j} ) )}{exp ( F ( Xi \vert {λ}_{{w}_{i}^{T}} ) )} ]$$
such that the training criterion is defined as
$$\tilde{Λ} = {argmin}_{Λ} [ {max}_{Xi ∈ S , {w}_{j} ∈ Ω , {w}_{j} \neq {w}_{i}^{T}} exp ( F ( {X}_{i} \vert λ {w}_{j} ) - F ( {X}_{i} \vert {λ}_{{W}_{i}^{T}} ) ) - 1 ]$$
where λ_{W} denotes a model representing a word W, F(X|λ_{W})=p(W) p(X|λ_{W}) and Ω denotes the set of all possible words.

19. The discriminative training method of claim 17 wherein solving the constrained minimax optimization problem uses a generalized probabilistic descent algorithm.

20. The discriminative training method of claim 18 wherein solving the constrained minimax optimization problem uses a generalized probabilistic descent algorithm.

21. A discriminative training method for acoustic models, comprising:
defining a measure of separation margin for the data;
identifying a subset of training utterances having utterances recognized by the acoustic models and utterances misrecognized by the acoustic models;
defining a training criterion for the acoustic models based on maximum margin estimation;
formulating the training criterion as a minimax optimization problem; and
solving the constrained minimax optimization problem over the subset of training utterances, thereby discriminatively training the acoustic models.
